(19) United States
(12) Patent Application Publication
(10) Pub. No.: US 2022/0228416 A1
(43) Pub. Date: Jul. 21, 2022

(54) SLIDING DOOR OPERATOR SYSTEM

(71) Applicant: Assa Abloy Entrance Systems AB, Landskrona (SE)

(72) Inventors: Roger DRYER, Bjarred (SE); Patrik LERPARD, Limhamn (SE); Ivan RAJIC, Lund (SE); Jonatan NILSSON, Goteborg (SE); David ANDERSSON, Goteborg (SE); Jonas BLOMQVIST, Goteborg (SE); Meher Chaitanya KAMARAJU, Goteborg (SE); Suhas SRINIVAS, Goteborg (SE); Zoltan MICHIS, Lund (SE)

(21) Appl. No.: 17/611,425

(22) PCT Filed: May 12, 2020
(86) PCT No.: PCT/EP2020/063142

§ 371 Date: Nov. 15, 2021

(30) Foreign Application Priority Data
May 22, 2019 (SE) 1930167-0

(51) Int. Cl. E05F 15/632; E05F 15/70; H01M 10/46

(52) U.S. Cl. CPC E05F 15/632; E05F 15/70; H01M 10/46; E05Y 2201/434; E05Y 2201/64; H01M 2220/20; E05Y 2400/415; E05Y 2400/44; E05Y 2400/614; E05Y 2900/132; E05Y 2201/684

(57) ABSTRACT

The disclosure relates to a sliding door operator system (1) for opening and closing an opening (2), comprising: a track (3) configured to be mounted at an upper part (21) of the opening (2), one or more sliding door(s) 10 slidably connected to the track (3) and comprising a door leaf (4) configured to be moved along the track (3) between an open (o) and closed (c) position, and a drive unit (5) mounted on the door leaf (4), moveably connected to the track (3) and arranged to move the door leaf (4) between the closed position (c) and the open position (o). The disclosure further relates to a drive unit (5) for moving a sliding door leaf (4) between an open and a closed position (O, C) and a control system (11) for regulating one or more sliding door (10).

### FIELD OF THE INVENTION

The present invention relates to a door operator system for opening and closing an opening. The present invention relates to a sliding door operator system for opening and closing an opening, a drive unit for moving a sliding door leaf between an open and a closed position and a control system for regulating one or more sliding door. More specifically, the disclosure relates to a sliding door operator system for opening and closing an opening, a drive unit for moving a sliding door leaf between an open and a closed position and a control system for regulating one or more sliding door as defined in the introductory parts of claim 1, claim 33 and claim 52.

### BACKGROUND OF THE INVENTION

A sliding door operator system for a sliding door typically comprises a door connected to a track and an endless belt and a drive unit arranged to move the door along the track between an open and closed position for opening and closing the opening by moving the belt. A sliding door are typically used at openings where large numbers of persons pass through, such as doors at stores and offices, or at openings where the door should open without contact from the person passing through the opening, such as doors in hospitals.

There is a need for a more flexible sliding door that could be regulated in a more flexible way and that could reduce the flow of air and particles through the opening and between the two sides of the door to reduce the need of heating, cooling and/or cleaning the air in a room or a building.

### SUMMARY OF THE INVENTION

It is an object to mitigate, alleviate or eliminate one or more of the above-identified deficiencies in the art and disadvantages singly or in any combination and solve at least the above mentioned problem.

An object of the present invention is to reduce the complexity of the sliding door operator system.

An object of the present invention is to increase the possibilities of how the door leafs of a sliding door operator system could be moved.

According to a first aspect there is provided a sliding door operator system for opening and closing an opening, comprising: a track configured to be mounted at an upper part of the opening, one or more sliding door(s) slidably connected to the track and comprising a door leaf configured to be moved along the track between an open and closed position, and a drive unit mounted on the door leaf, moveably connected to the track and arranged to move the door leaf between the closed position and the open position.

By having the drive unit mounted on the door leaf, each door leaf could be moved individually and the size and position of the opening could be regulated based on each situation and need.

According to some embodiments, the drive unit comprises at least one wheel arranged in the track and at least one motor connected to the wheel and configured to rotate the wheel to slidably move the door leaf along the track.

According to some embodiments, the drive unit comprises a battery connected to the motor and configured to power the motor. By having the battery powering the motor the number of connections between moving parts could be reduced.

According to some embodiments, the drive unit comprises a capacitor connected to the motor and configured to power the motor. By having the capacitor powering the motor, the number of connections between moving parts could be reduced. Further, the charging time for a capacitor is low, such that it could be charged even if it should be operated at high intervals.

According to some embodiments, the sliding door operator system comprises a charger station, wherein the battery and/or capacitor is configured to be connected to the charger station and to be charged by the charger station.

According to some embodiments, the battery and/or the capacitor is configured to be connected to the charging station when the door leaf is positioned in the open position and/or the closed position.

According to some embodiments, the charger station comprises at least a first charging unit, arranged to be connected to and to charge the battery and or capacitor when the door leaf is in the open position.

According to some embodiments, the charger station comprises at least a second charging unit, arranged to be connected to and to charge the battery and/or the capacitor when the door leaf is in the closed position.

According to some embodiments, the drive unit comprises a bogie and the wheel is suspended in a wheel suspension of the bogie.

According to some embodiments, the bogie is connected to the door leaf.

According to some embodiments, the battery is mounted on the bogie.

According to some embodiments, the capacitor is mounted on the bogie.

According to some embodiments, the motor is arranged in the wheel.

According to some embodiments, the motor constitutes a center shaft of the wheel.

According to some embodiments, the wheel is configured to rotate around at least parts of the motor.

According to some embodiments, the motor is mounted on the bogie.

According to some embodiments, the one or more sliding door comprises a control unit configured to regulate the drive unit to move the door leaf between the closed position and the open position.

According to some embodiments, the sliding door operator system comprises one or more sensors configured to detect objects at the sliding door operator system.

According to some embodiments, at least one of the sensors is mounted on at least one of the sliding door.

According to some embodiments, the sliding door comprises at least two drive units.

According to some embodiments, the sliding door operator system comprises a first and a second sliding door and a control system, wherein the control system is configured to regulate the first sliding door to move between the open and closed position of the first sliding door and to regulate the second sliding door to move between its open and closed position of the second sliding door.

According to some embodiments, the control system is configured to regulate the movement of the first sliding door independently of the movement or position of the second sliding door.

According to some embodiments, the control system is configured to regulate the movement of the first and second sliding doors at least based on input from the one or more sensors.

According to some embodiments, the control system is connected to the control unit of each sliding door and configured to regulate the control unit to regulate the drive unit to move the door leaf.

According to some embodiments the door leaf 4 is connected to the drive unit via a connector.

According to some embodiments the sliding door operator system comprises two tracks.

According to some embodiments the drive unit comprises at least a pair of wheels According to some embodiments the pair of wheels are arranged on an axle.

According to some embodiments the drive unit comprises two or more pair of wheels.

According to some embodiments one wheel of the pair of wheels is arranged on one track and the other wheel of the pair of wheels is arranged on the other track. Put in another way, each wheel of the pair of wheels is positioned on a separate track.

According to some embodiments, the drive unit comprises at least one a spline joint connected between the wheel and the motor and arranged to compensate for movements in an axial direction of the wheel in relation to the motor.

According to some embodiments, the track is configured to restrict movement of the wheel in the axial direction of the wheel.

According to some embodiments, a rolling surface of the wheel and a rolling surface of the track have a corresponding shape.

According to some embodiments, the rolling surface of the wheel and the rolling surface of the track is made of a material with a higher friction than other surfaces of the track and the wheel to restrict the wheel from spinning or sliding in the track.

According to some embodiments, a cross sectional shape of the track has a c-shape or a u-shape.

According to some embodiments, the track comprises restriction parts configured to restrict movements of the wheel in the axial direction of the wheel. Put in another way, to restrict movements in a horizontal direction that is perpendicular to the extension of the track.

According to some embodiments, the drive unit comprises a gear box connected to the wheel and the motor and configured to transfer movements from the motor to the wheel.

According to a second aspect there is provided a drive unit for moving a door leaf between an open and a closed position, wherein the drive unit is configured to be mounted on a door leaf and to interact with a track at an upper part of an opening to move the door leaf and the drive unit in relation to the track.

According to some embodiments, the drive unit comprises at least a wheel and a motor, wherein the motor is connected to the wheel and configured to rotate the wheel, and the wheel is configured to be arranged in the track.

According to some embodiments, the drive unit comprises a battery connected to the motor and configured to power the motor.

According to some embodiments, the drive unit comprises a capacitor connected to the motor and configured to power the motor.

According to some embodiments, the battery and or capacitor is configured to be connected to a charger station and to be charged by the charger station.

According to some embodiments, the battery and/or the capacitor is configured to be connected to the charging station when the door leaf is positioned in the open position and/or the closed position.

According to some embodiments, the drive unit comprises a bogie and wherein the wheel is suspended in a wheel suspension of the bogie.

According to some embodiments, the bogie is configured to be connected to the door leaf.

According to some embodiments, the battery is mounted on the bogie.

According to some embodiments, the capacitor is mounted on the bogie.

According to some embodiments, the motor is arranged in the wheel.

According to some embodiments, the motor constitutes a center shaft of the wheel.

According to some embodiments, the motor constitutes a center shaft of the wheel.

According to some embodiments, the wheel is configured to rotate around at least parts of the motor.

According to some embodiments, the motor is mounted on the bogie.

According to some embodiments, the drive unit comprises at least one a spline joint connected between the wheel and the motor and arranged to compensate for movements in an axial direction of the wheel in relation to the motor. By having a spline joint, the wear on the connection between the door frame and the drive unit can be reduced.

According to some embodiments, a rolling surface of the wheel has a corresponding shape as a rolling surface of the track.

According to some embodiments, the rolling surface of the wheel is made of a material with a higher friction than other surfaces of the wheel to restrict the wheel from spinning or sliding in the track.

According to some embodiments, a side surface of the wheel is made of a material with a lower friction than other surfaces of the wheel.

According to some embodiments, the drive unit comprises a gear box connected to the wheel and the motor and configured to transfer movements from the motor to the wheel.

According to a third aspect there is provided a control system for regulating one or more sliding door according to any of the first aspect, comprising a central control unit configured to be connected to a control unit of the sliding door and to regulate the control unit to move a door leaf of the sliding door between an open and a closed position.

According to some embodiments, the central control unit is configured to regulate each control unit individually and independently of the other sliding doors.

Effects and features of the second and third aspects are to a large extent analogous to those described above in connection with the first aspect. Embodiments mentioned in relation to the first aspect are largely compatible with the second and third aspects.

A further scope of applicability of the present invention will become apparent from the detailed description given below. However, it should be understood that the detailed description and specific examples, while indicating preferred embodiments of the invention, are given by way of illustration only. Various changes and modifications within the scope of the invention will become apparent to those skilled in the art from the detailed description.

Hence, it is to be understood that the herein disclosed invention is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

The above objects, as well as additional objects, features and advantages of the present invention, will be more fully appreciated by reference to the following illustrative and non-limiting detailed description of example embodiments of the present invention, when taken in conjunction with the accompanying drawings.

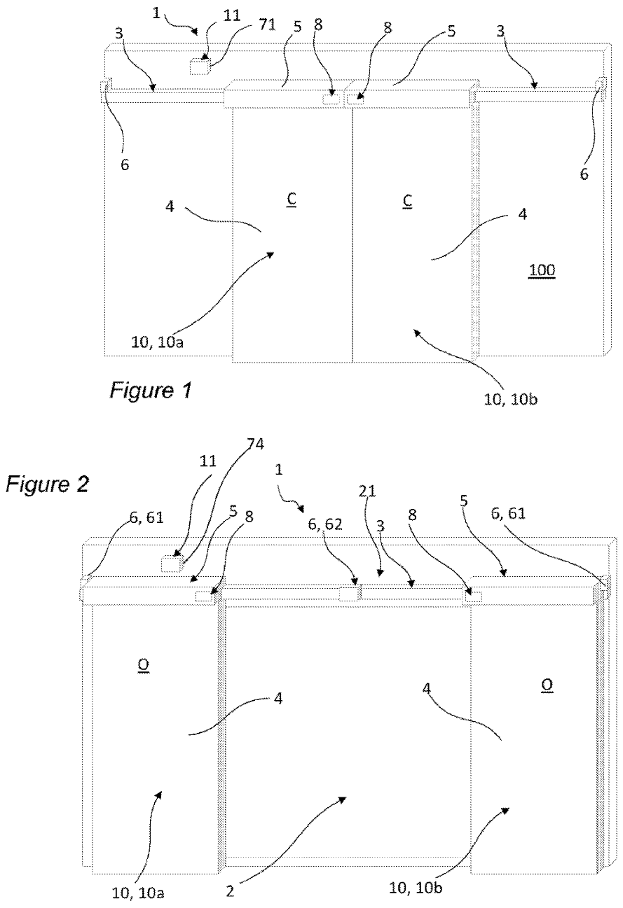

FIG. 1 discloses a schematic front view of a sliding door operator system in a closed position.

FIG. 2 discloses a schematic front view of a sliding door operator system in an open position.

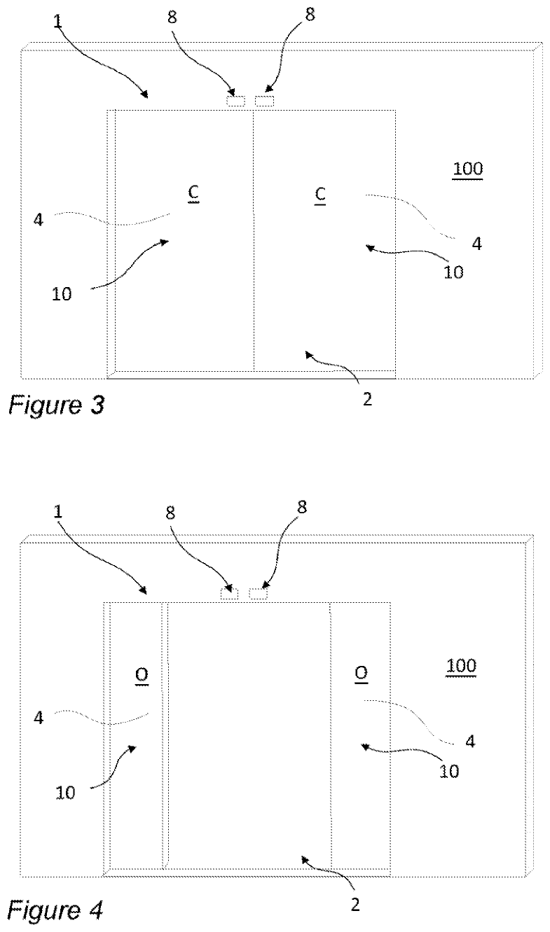

FIG. 3 discloses a schematic rear view of a sliding door operator system in a closed position.

FIG. 4 discloses a schematic rear view of a sliding door operator system in an open position.

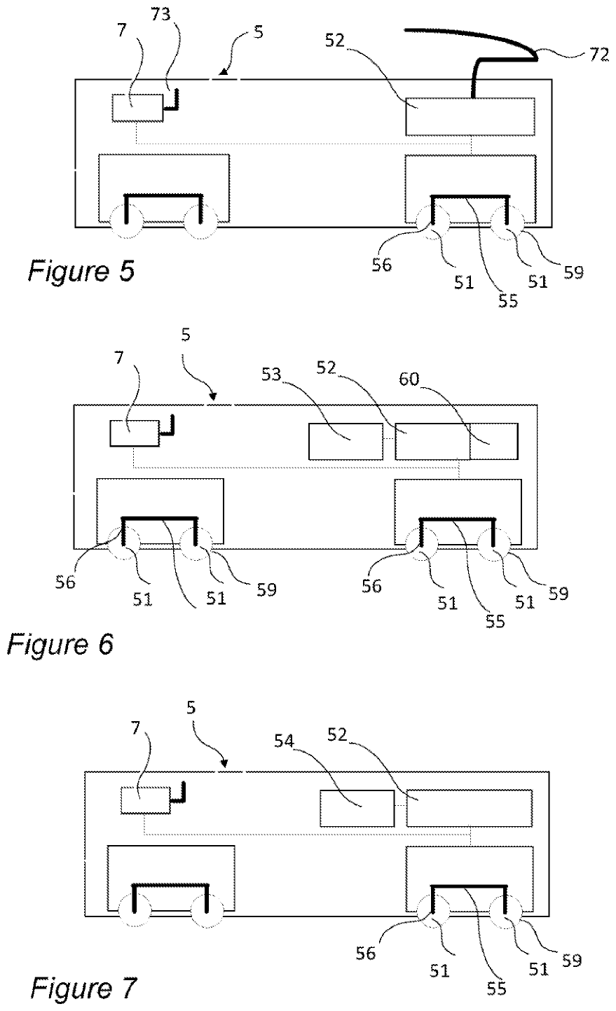

FIG. 5 discloses a schematic view of a drive unit comprising a control unit and fixed electric connection.

FIG. 6 discloses a schematic view of a drive unit comprising a control unit and a battery.

FIG. 7 discloses a schematic view of a drive unit comprising a control unit and a capacitor.

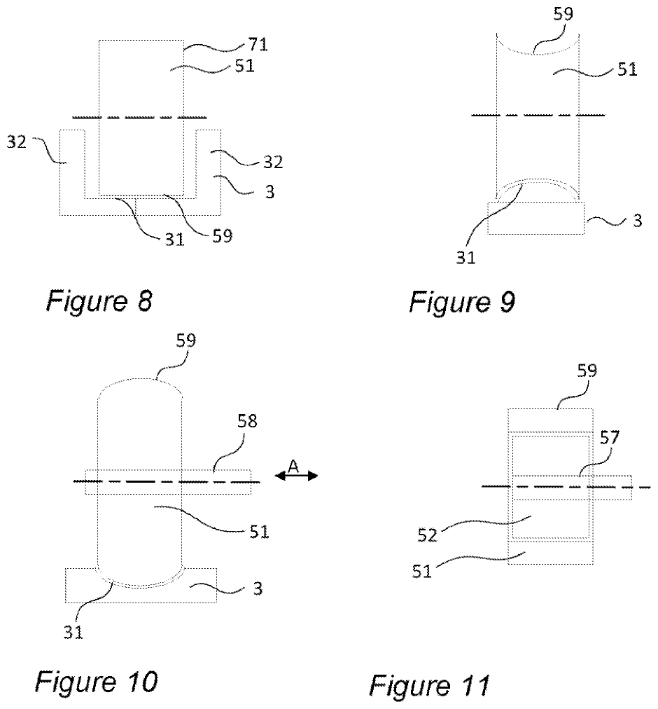

FIG. 8 discloses a cross sectional view of a track and a wheel.

Figure discloses a cross sectional view of a track and a wheel.

FIG. 10 discloses a cross sectional view of a track and a wheel comprising a spline joint.

FIG. 11 discloses a cross sectional view of a track, a wheel and a motor arrange inside the wheel.

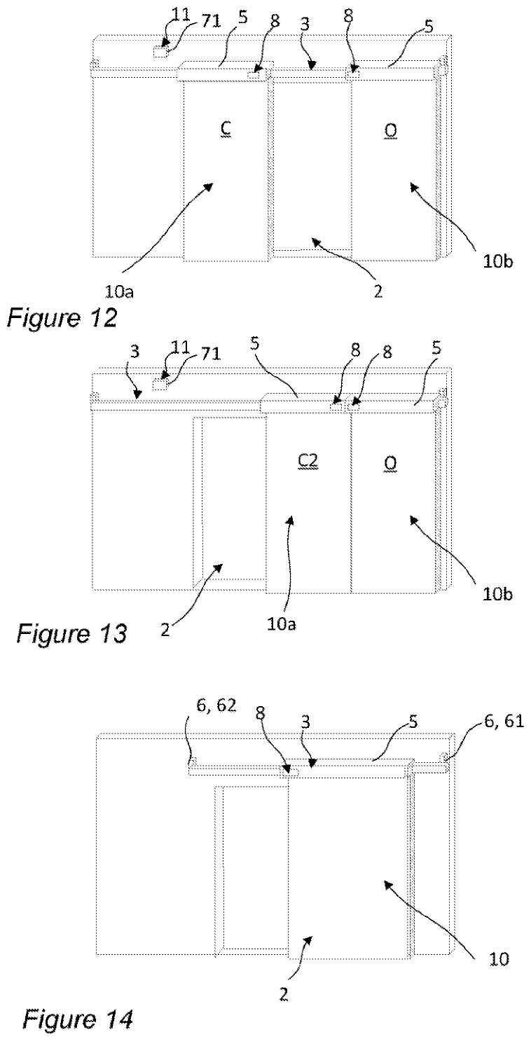

FIG. 12 discloses a schematic perspective view of a sliding door operator system with a first sliding door in a closed position and a second sliding door in an open position.

FIG. 13 discloses a schematic perspective view of a sliding door operator system with a first sliding door in a second closed position and a second sliding door in an open position.

FIG. 14 discloses a schematic perspective view of a sliding door operator system with a first sliding door in an intermediate position between the open and closed position.

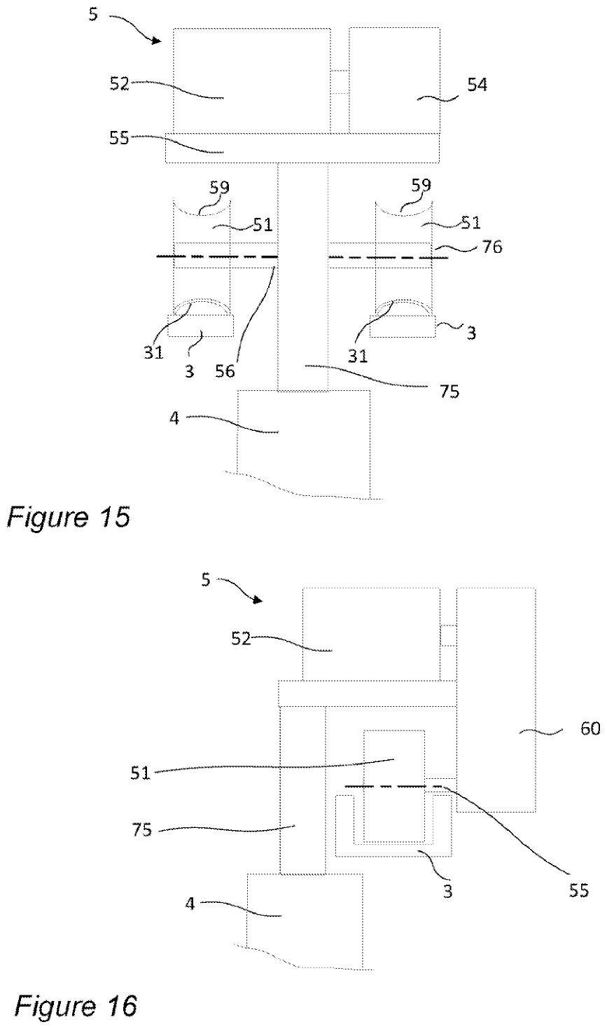

FIG. 15 discloses a schematic cross sectional view of a drive unit, track and a door leaf according to an embodiment.

FIG. 16 discloses a schematic cross sectional view of a drive unit, track and a door leaf according to an embodiment.

### DETAILED DESCRIPTION

The present invention will now be described with reference to the accompanying drawings, in which currently preferred example embodiments and aspects of the invention are shown. This invention may, however, be embodied in many different forms and should not be construed as limited to the herein disclosed embodiments. The features of embodiments and aspects could be combined with features of other embodiments and aspects. Separate features of embodiments and aspects could be combined with separate features of other embodiments and aspects. The disclosed embodiments are provided to fully convey the scope of the invention to the skilled person.

FIGS. 1 and 2 shows a sliding door operator system 1. The sliding door operator system 1 is configured to open and closing an opening 2 in a wall 100. In a sliding door operator system 1, sliding door(s) are moved in parallel to the width of the opening

The first aspect of this disclosure shows a sliding door operator system 1 for opening and closing the opening 2 in the wall 100. The sliding door operator system 1 comprises a track 3, one or more sliding door(s) 10. The track 3 is configured to be mounted at an upper part 21 of the opening 2. The track 3 is substantially horizontal positioned above the opening 2. In FIGS. 1, 2 & 14 the track 3 is mounted to a part of the wall 100 that is above the opening 2. The sliding door 10 are slidably connected to the track 3. The sliding door 10 comprises a door leaf 4 and a drive unit 5. The door leaf 4 is configured to be moved along the track 3 between an open O and closed C position. The drive unit 5 is mounted on the door leaf 4. The drive unit 5 is moveably connected to the track 3. The drive unit 5 is arranged to move the door leaf 4 between the closed position C and the open position O.

The drive unit 5 is disclosed in more detail in FIGS. 5-7. According to an aspect the drive unit 5 comprises at least one wheel 51 and at least one motor 52. The wheel 51 is arranged in the track 3. The at least one motor 52 is connected to the wheel 51. The motor 52 is configured to rotate the wheel 51 to slidably move the door leaf 4 along the track 3. The drive unit 5 thereby is adapted to move the door leafs 4 back and forward between their open and closed positions O, C and any intermediate position between the open and closed positions O, C. According to an aspect the at least one motor 52 of the drive unit 5 is a direct current DC motor 51. According to an aspect and as is disclosed in FIG. 5, the motor 52 is connected to a fixed power source (not disclosed) via a cable 71. The drive unit 5 comprises one or several wheels 51. The motor 52 could be configured to rotate one or more of the wheels 51. According to an aspect the motor 52 is configured to rotate one wheel 51 of the drive unit 5. According to an aspect the motor 52 is configured to rotate two wheels 51 of the drive unit 5. According to an aspect the motor 52 is configured to rotate all wheels 51 of the drive unit 5. According to an aspect the drive unit 5 comprises one or more wheels 51 that is not rotated by the motor 52, i.e. not all the wheels 51 of the drive unit 5 is directly connected to the motor 51, however the wheels 51 are rotated indirectly by the motor 52 as the drive unit 5 is moved along the track 3.

According to an aspect, as is disclosed in FIG. 6, the drive unit 5 comprises a battery 53 connected to the motor 52. The battery 53 is configured to power the motor 51.

According to an aspect and as is disclosed in FIG. 7, the drive unit 5 comprises a capacitor 54 connected to the motor 52. The capacitor 54 is configured to power the motor 51.

According to an aspect and as is disclosed in FIG. 7, the drive unit 5 comprises a gear box 60 connected to the wheel 51 and the motor 52. The gear box 60 is configured to transfer movements from the motor 52 to the wheel 51.

According to an aspect the drive unit 5 comprises the battery 53 and the capacitor 54 and both are connected to the motor 52

According to an aspect the drive unit 5 comprises a wagon/bogie 55. The wheel 51 is suspended in a wheel suspension 56 of the bogie 55.

According to an aspect the bogie 55 is connected to the door leaf 4. According to an aspect the bogie 55 is mounted to the door leaf 4.

According to an aspect the battery 52 is mounted on the bogie 55. According to an aspect the capacitor 54 is mounted on the bogie 55.

According to an aspect the motor 51 is mounted on the bogie 55.

According to an aspect and as is disclosed in FIG. 11 the motor 52 is arranged in the wheel 51. The motor 52 constitutes a center shaft of the wheel 51. The wheel 51 is configured to rotate around at least parts of the motor 52

According to an aspect and as is disclosed in FIGS. 1 and 2, the sliding door operator system 1 comprises a charger station 6. The battery 53 and the capacitor 54 is configured to be connected to the charger station 6 and to be charged by the charger station 6. According to an aspect the battery 53 is configured to be connected to the charger station 6 and to be charged by the charger station 6. According to an aspect the capacitor 54 is configured to be connected to the charger station 6 and to be charged by the charger station 6.

The charger station 6 comprises according to an aspect a first charging unit 61. According to an aspect the sliding door operator system 1 comprises one first charging unit 61 that is arranged at one end of the track 3, as is disclosed in FIG. 14. According to an aspect the sliding door operator system 1 comprises two first charging units 61 that are arranged at the ends of the track 3, one at each end of the track 3 as is disclosed in FIGS. 1 and 2. The first charging unit 61 is arranged to be connected to and to charge the battery 53 and or capacitor 54 when the door leaf 4 is in the open position O.

The charger station 6 comprises according to an aspect at least a second charging unit 62 arranged to be connected to and to charge the battery 53 and/or the capacitor 54 when the door leaf 4 is in the closed position O, as is disclosed in FIGS. 2 and 14.

The battery 53 and the capacitor 53 is configured to be connected to the charging station 6 when the door leaf 4 is positioned in the open position O and/or the closed position C. The battery 53 is according to an aspect configured to be connected to the charging station 6 when the door leaf 4 is positioned in the open position O and/or the closed position C. The capacitor 53 is according to an aspect configured to be connected to the charging station 6 when the door leaf 4 is positioned in the open position O and/or the closed position C.

According to an aspect the sliding door 10 comprises a control unit 7. The control unit 7 is configured to regulate the drive unit 5 to move the door leaf 4 between the closed position C and the open position O.

According to an aspect the sliding door operator system 1 comprises a control system 11. According to an aspect the control system 11 comprises a central drive unit 71. According to an aspect the central drive unit 71 is mounted to a non moving part of the sliding door operator system 1 or to the wall 100. According to an aspect the central drive unit 71 is mounted to a moving part of the sliding door operator system 1 or to the wall 100. According to an aspect the control unit 7 of the sliding door 10 comprises the central drive unit 71. Put in another way, the control unit 7 of the door is a combined control unit 7 for the sliding door 10 and the control system 11.

According to an aspect the sliding door operator system 1 comprises one or more sensors 8, as is disclosed in FIGS. 1-4 and 14. The sensors 8 are configured to detect objects at the sliding door operator system 1. According to an aspect and as is disclosed in FIGS. 1, 2 and 14, the sensor 8 is mounted on the sliding door 10. According to an aspect and as is disclosed in FIGS. 2 and 4, the sensor 8 is mounted on the wall 100. According to an aspect the sliding door operator system 1 comprises one or more sensors 8 that are mounted on the sliding door 10 and one or more sensors 8 that are mounted on non moving parts of the sliding door operator system 1, such as the track 3, or at the wall 100. The sensors 8 that are positioned on the side of the wall 100 that the sliding door operator system 1 is positioned at, i.e. the front side of the sliding door operator system 1 as disclosed in FIGS. 1 and 2, are mounted at the drive unit 5 of the sliding door 10. The sensors 8 that are positioned on the side of the wall 100 that the sliding door operator system 1 is not positioned at, i.e. the backside of the sliding door operator system 1 as disclosed in FIGS. 3 and 4, are mounted at the wall 100.

According to an aspect the sensors 8 are arranged to identify a person or object in the path of the sliding door 10 and to send a signal to the control unit 7 when identifying the person or object. The one or more sensors 8 are according to an aspect one or more of a pressure sensor, an IR-sensor, a camera, a radar or a presence sensor.

According to an aspect the sliding door 10 comprises at least two drive units 5. If the door leaf 4 is big or heavy, two or more drive units 5 could be connected to one door leaf 4 instead of increasing the strength of the motor 52 and/or the dimension of the drive unit 5.

According to an aspect, as is disclosed in FIG. 1-4, the sliding door operator system 1 comprises a first sliding door 10, 10a and a second sliding door 10,10b. The control system 11 is configured to regulate the first sliding door 10a to move between the open and closed position O, C of the first sliding door 10a. The control system 11 is configured to regulate the second sliding door 10b to move between its open and closed position O, C of the second sliding door 10b. According to an aspect the control system 11 is configured to move the first and second doors 10a, 10b by being connected to and configured to regulate the control units 7 of each sliding door 10a, 10b. According to an aspect the control system 11 is configured to move the first and second doors 10a, 10b by being connected to the drive unit 5 of each sliding door 10a, 10b.

According to an aspect the control system 11 is configured to regulate the movement of the first sliding door 10a independently of the movement or position of the second sliding door 10b. According to an aspect and as disclosed in FIG. 12 the control system 11 regulate the second sliding door 10b to move to its open position O and keep the first sliding door 10a in its closed position C. According to an aspect the as disclosed in FIG. 13 the control system 11 regulate the second sliding door 10b to move to its open position O and to move the first sliding door 10a to a second closed position C2. By this the size and position of the opening could be adapted to different situations and needs. If for instance a person is approaching the second sliding door 10b, there is no need for both the first and the second sliding doors 10a, 10b to be opened and only the second sliding door 10b could be opened. By this the energy usage of the sliding door operator system 1 could be reduced compared to if both doors are moved and the leakage of hot or cold air through the opening 2 could be reduced.

According to an aspect, as is disclosed in FIG. 14, the sliding door operator system 1 comprises one sliding door 10. The control system 11 is configured to regulate the sliding door 10 to move between the open and closed position O, C.

According to an aspect, the sliding door operator system 1 comprises a telescopic sliding door 10. According to an aspect the sliding door 10 comprises two or more door leafs 4. Each door leaf 4 being telescopically connected to the other door leafs 4 of the sliding door 10. The control system 11 is configured to regulate the sliding door 10 to move between the open and closed position O, C and to move each door leaf 4 separately.

According to an aspect the control system 11 is configured to regulate the movement of the first and second sliding doors 10a, 10b at least based on input from the one or more sensors 8.

According to an aspect the control system 11 is connected to the control unit 7 of each sliding door 10 and configured to regulate the control unit 7 to regulate the drive unit 5 to move the door leaf 4.

According to an aspect the drive unit 5 comprises at least one a spline joint 58 connected between the wheel 51 and the motor 52, as is disclosed in FIG. 8. The spline joint 58 is arranged to compensate for movements in an axial direction A of the wheel 51 in relation to the motor 52.

The wheel 51 is configured to be inserted into the track 3. The wheel 51 is arranged to interact with the track 3 and to restrict horizontal movement perpendicular to the track 3 of the wheel 51 when the wheel 51, and thus also the drive unit 5 and the door leaf 4, is moved between the open and closed position O, C of the door leaf 4. According to an aspect, the spline joint 58 is in one end connected to the wheel 51 and in a second end connected to the motor 52 or the gear box 60. As the track 3 according to an aspect is arranged to restrict horizontal movement of the wheel 51 perpendicular to the extension of the track 3 and the wheel 51 is connected to the motor 52, the spline joint 58 will move and compensate for any horizontal movement of the motor 52 and the door leaf 4 in relation to the wheel 51. The spline joint 58 will be compressed when the distance between the motor 52 and the wheel 51 decreases. The spline joint 58 will be extracted when the distance between the motor 52 and the wheel 51 increases.

According to an aspect the track 3 is configured to restrict movement of the wheel 51 in the axial direction of the wheel 51. Put in another way, in a direction that is perpendicular to the extension of the track 3.

According to an aspect the wheel 51 comprises a rolling surface 59, as is disclosed in FIG. 8-11. According to an aspect the track comprises a rolling surface 31 as is disclosed in FIG. 8-11. The rolling surface 59 of the wheel 51 is configured to roll on the rolling surface 31 of the track 3 when the drive unit 5 is moved along the track 3. According to an aspect the rolling surface 59 of the wheel 51 and a rolling surface 31 of the track 3 have a corresponding shape, as is disclosed in FIG. 8-10.

According to an aspect a cross sectional shape of the track 3 has a C-shape, as is disclosed in FIG. 10. According to an aspect the cross sectional shape of the track 3 has a U-shape, as is disclosed in FIG. 8. According to an aspect the cross sectional shape of the track 3 has a convex shape, as is disclosed in FIG. 9.

According to an aspect a cross sectional shape of the rolling surface 59 of the wheel 51 has a C-shape, as is disclosed in FIG. 10. According to an aspect the cross sectional shape of the rolling surface 59 of the wheel 51 has a U-shape, as is disclosed in FIG. 8. According to an aspect the cross sectional shape of the rolling surface 59 of the wheel 51 has a concave shape, as is disclosed in FIG. 9.

According to an aspect the rolling surface of the wheel 51 and the rolling surface of the track 3 is made of a material with a higher friction than other surfaces of the track 3 and the wheel 51 to restrict the wheel 51 from spinning or sliding in the track 3. By having a material of a higher friction, more force from the wheel 51 can be exerted on the track 3 to move the sliding door 10 without the wheels 51 spinning on the track 3. The higher friction is also useful when the movement of the sliding door 10 should be stopped to avoid the wheels 51 from sliding on the track 3.

According to an aspect the track 3 comprises restriction parts 32, as is disclosed in FIG. 8. The restriction parts 32 is configured to restrict movements of the wheel 51 in the axial direction of the wheel 51.

According to an aspect the control unit 7 of the sliding door 10 is wireless connected to the control system 11 via a connection 73.

According to an aspect and as is disclosed in FIG. 15, the sliding door operator system 1 comprises two tracks 3 and the drive unit 5 comprises at least two wheels 51. The two wheels 51 are arranged as a pair of wheels 51. The pair of wheels 51 according to an aspect share the same axle 76. The motor 52 is configured to rotate the axle 76 to rotate the wheels 51. The drive unit 5 comprises according to an aspect two or more pair of wheels 51. One track 3 is positioned on one side of the door leaf 4 and the other track 3 is positioned on the other side of the door leaf 4. Put in another way the door leaf 4 is positioned between the two tracks 3. One wheel 51 of the pair of wheels is arranged on one track 3 and the other wheel 51 of the pair of wheels is arranged on the other track 3. Put in another way, each wheel 51 of the pair of wheels is positioned on a separate track 3. The wheels 51 is connected to the wheel suspension 56 of the bogie 55. The motor 52 and the capacitor 54 is connected to the bogie 55. The door leaf 4 is connected to the drive unit 5 by a connector 75. By having two tracks 3 the forces from the sliding door 10 on the tracks 3 could be balanced to reduce any turning forces acting on the sliding door operator system 1.

According to an aspect and as is disclosed in FIG. 16, the sliding door operator system 1 comprises one track 3 and the drive unit 5 comprises at least one wheel 51. The wheel 51 is connected arranged in the track 3. The gear box 60 is connected to the wheel 51 and the motor 52 and configured to transfer forces from the motor 52 to the wheel 51 to rotate the wheel 51 in the track 3 to move the sliding door 10 along the track 3. The gear box 60 is positioned on one side of the track 3. The door leaf 4 is connected to the drive unit 5 via the connector 75. The connector 75 is positioned on the other side of the track 3. Parts of the drive unit 5 such as the motor 52, battery 53, capacitor 54 and/or gear box 60, are according to an aspect positioned and used as a counter weight in relation to the weight of the door leaf 4 to balance the sliding door 10 on the track 3 and to reduce any turning forces acting on the sliding door operator system 1.

According to an aspect the different parts could be wirelessly connected. According to an aspect the wireless connection comprises a radio communication interface. The radio communication interface may be comprised as any number of tranceiving, receiving, and/or transmitting units or circuitry. It should further be appreciated that the radio communication interface may be in the form of any input/output communications port known in the art. The radio communication interface may comprise RF circuitry and baseband processing circuitry. The radio communication interface may support either wireless and/or wired communication. Examples of wireless communication may be Global System for Mobile Communication, GSM, Bluetooth, narrowband communication, Internet of Things, IoT, specific communication.

According to an aspect the radio communication interface is configured to send data associated with the sliding door 10 and or the sliding door operator system 1 to one or more remote entity. According to an aspect the data is data relating to the movement of the sliding doors 10, the need for service of the sliding door operator system 1 and/or the environment conditions at the sliding door operator system 1.

According to an aspect, the one or more remote entity is a server, a database, a further sliding door entrance system 1 and/or the cloud.

According to an aspect the sliding door entrance system 1 further comprises a wireless connection interface suitable for sending electronic signals. Examples of wireless connections are Bluetooth™, WiFi, Infrared or any kind of near field communication technology.

According to an aspect the control unit 7 and/or the control system 11 comprises a central processor unit (CPU) and a memory (not disclosed).

According to an aspect, the sensor 8 and/or the drive unit 5 comprises a wireless connection unit suitable for sending electronic signals. The connection is a wireless connection. Examples of wireless connections are Bluetooth™, WiFi, Infrared or any kind of near field communication technology.

The second aspect of this disclosure shows a drive unit 5 according to the above for moving a door leaf 4 between an open and a closed position O, C. The drive unit 5 is configured to be mounted on the door leaf 4 and to interact with the track 3 at an upper part 21 of an opening 2 to move the door leaf 4 and the drive unit 5 in relation to the track 2.

The drive unit 5 comprises at least a wheel 51 and a motor 52, wherein the motor 52 is connected to the wheel 51 and configured to rotate the wheel 51, and the wheel 51 is configured to be arranged in the track 3. According to an aspect the drive unit 5 comprises a battery 53 connected to the motor 51 and configured to power the motor 51.

According to an aspect the drive unit 5 comprises the capacitor 54 connected to the motor 51 and configured to power the motor 51.

According to an aspect the battery 53 and or capacitor 54 is configured to be connected to a charger station 6 and to be charged by the charger station 6. According to an aspect the battery 53 and/or the capacitor 54 is configured to be connected to the charging station 6 when the door leaf 4 is positioned in the open position O and/or the closed position C. According to an aspect the drive unit 5 comprises the bogie 55 and wherein the wheel 51 is suspended in a wheel suspension 56 of the bogie 55. The bogie 55 is a bogie or a wagon to which one or more wheels 51 are connected. The wheels 51 could be connected via the wheel suspension 56. According to an aspect the bogie 55 is configured to be connected to the door leaf 4. According to an aspect the battery 53 is mounted on the bogie 55.

According to an aspect the capacitor 54 is mounted on the bogie 55. According to an aspect the motor 52 is arranged in the wheel 51. According to an aspect the motor 52 constitutes a center shaft 57 of the wheel 51.

According to an aspect the wheel 51 is configured to rotate around at least parts of the motor 52. According to an aspect the motor 51 is mounted on the bogie 55.

According to an aspect the drive unit 5 comprises the at least one spline joint 58 connected between the wheel 51 and the motor 52 and arranged to compensate for movements in an axial direction of the wheel 51 in relation to the motor 52.

According to an aspect the rolling surface 59 of the wheel 51 has the corresponding shape as the rolling surface 31 of the track 3.

According to an aspect the rolling surface of the wheel 51 is made of a material with a higher friction than other surfaces of the wheel 51 to restrict the wheel 51 from spinning or sliding in the track 3. According to an aspect a side surface 71 of the wheel 51 is made of a material with a lower friction than other surfaces of the wheel 51.

According to an aspect the drive unit 5 comprises the gear box 60 connected to the wheel 51 and the motor 52 and configured to transfer movements from the motor 52 to the wheel 51.

The third aspect of this disclosure shows a control system 11 for regulating one or more sliding doors 10 according to any of the first aspect, comprising a central control unit 74 configured to be connected to a control unit 7 of the sliding door 10 and to regulate the control unit 7 to move a door leaf 4 of the sliding door 10 between an open and a closed position.

According to an aspect the central control unit 74 is configured to regulate each control unit 7 individually and independently of the other sliding doors 10.

The person skilled in the art realizes that the present invention is not limited to the preferred embodiments described above. The person skilled in the art further realizes that modifications and variations are possible within the scope of the appended claims. Additionally, variations to the disclosed embodiments can be understood and effected by the skilled person in practicing the claimed invention, from a study of the drawings, the disclosure, and the appended claims.

Hereafter a method of how the sectional door operator system 1 comprising two sliding doors 10 opens and closes the opening 2 will be described with reference to FIG. 1-4.

A person approaching the opening 2 will be detected by one or more sensors 8 of the sliding door operator system 1. The sensors 8 sends a signal to the control unit 7 of the sliding door 10. According to an aspect the control unit 7 of the sliding door 10 contacts the control system 11 by passing on the information from the sensors 8. According to an aspect the sensors 8 sends a signal to the control system 11 of the sliding door operator system 1.

The control system 11 regulates the control unit 7 of the first sliding door 10a and the control unit 7 of the second sliding door 10b to regulate the drive unit 5 of the first and second doors 10a, 10b to move the door leafs 4. The two door leafs 4 could be moved independently and be moved in different ways depending on different settings.

According to an aspect only one of the door leafs 4 is moved to its open position O when the person is approaching the sliding door operator system 1 to enter into a building through the opening 2 and the other door leaf 4 is only moved to its open position O when a person exits through the opening 2. By this the flow of persons could be controlled with one and the same sliding door operator system 1.

According to an aspect the door leafs 4 could be moved to the open position O to align the opening to with the direction that the person is heading, i.e. at the left, right or center of the opening 2. By this the size and shape of the opening could be reduced and regulated to the situation. If a single person is approaching the sliding door operator system 1, door leafs 4 could be moved to create a narrower opening than if several persons are approaching at the same time.

According to an aspect the door leafs 4 could be regulated in different ways depending on the weather conditions at the sliding door operator system 1 to reduce or increase the impact of the two sides of the opening being connected via the opening. According to an aspect the width of the opening 2 that the door leafs 4 is opened to is reduced if it is raining outside.

According to an aspect the two sliding doors 10a, 10b could be moved together as one single sliding door 10, as is disclosed in FIG. 13, by regulating the drive units 5 of the first and second doors 10a, 10b in the same way.

The motor 51 of the drive unit 5 rotates the wheel 51. The rotating wheel 51 will thereby move the drive unit 5 and the door leaf 4 it is mounted on along the track 3. The rolling surface 59 of the wheel 51 interacts with the rolling surface 31 of track 3. The restriction parts 32 interacts with the side surfaces 71 of the wheel 51 to keep the wheel 51 in the track 3 and to restrict it from moving in the horizontal direction perpendicular to the extension of the track 3. The higher friction at the rolling surfaces 59, 31 of the wheel 51 and the track 3 increases the force that can be transferred from the wheel 51 to the track 3 without the wheel 51 spinning or sliding. The surfaces of lower friction, i.e. the side surface 71 of the wheel 51 and the restriction parts 32 of the track 3, reduces the breaking force between the wheel 51 and the track 3 without reducing the ability of the restriction parts 32 to keep the wheel 51 in the track 3.

In the open position O of the door leaf 4, the battery 53 and or the capacitor 54 of the drive unit 5 could be connected to the first charger unit 61 and charge the battery 53 and or the capacitor 54.

If a further person is approaching the sliding door operator system 1 from either side, front or rear, the sensors 8 will detect the person(s) or object(s) and the control units 7 of the sliding door 10 and/or control system 11 will regulate the movement of the door leafs 4 based on the input from the sensors 8 and adapt the size and position of the opening 2 by regulating each drive unit 5 individually.

After the person has entered through the opening the control units 7 regulates the drive units 5 to move the door leafs 4 back to their closed positions C In the closed position the battery 53 and/or the capacitor 54 of the drive unit 5 of each sliding door 10a, 10b will be positioned at the second charger unit 62 and the battery 53 and/or the capacitor 54 could be charged.

According to an aspect the battery 53 connects mechanically with the charger station 6 to charge the battery 53. According to an aspect the battery 53 is charged contactless by the charger station 6.

By having the control unit 7 and/or the control system 11 configured to independently moving the door leafs 4 between their open and closed positions O, C, the opening could be adapted to the specific location and needs of the sliding door operator system 1.

The method of regulating the sliding door operator system 1 comprising one sliding door 10 will hereafter be described with reference to FIG. 14. A person approaching the opening 2 will be detected by one or more of the sensors 8. The sensor 8 will send a signal to the control unit 7 of the sliding door operator system 1. The control unit 7 receives the signal and will regulate the drive unit 5 to move the door leaf 4 based on the input from the sensor 8. The motor 52 of the drive unit 5 will rotate the wheel 51. The wheel 51 interacts with the track 3 and as the drive unit 5 and the door leaf 4 is connected to the wheel 51 the sliding door 10 will move along the track 3. The door leaf 4 is moved by the drive unit 5 from the closed position C to the open position O.

The battery 53 and or the capacitor 54 of the drive unit 5 is charged by the first charging unit 61 of the charging system 6, when the door leaf 4 is in the closed position C. The battery 53 and or the capacitor 54 of the drive unit 5 is charged by the second charging unit 62 of the charging system 6, when the door leaf 4 is in the open position O.

When the person has passed through the opening 2 and the sensors 8 do not detect any further person or object, the control unit 7 will regulate the motor 52 of the drive unit 5 to move the wheel 51, and thereby the whole sliding door 10 and its door leaf 4, from the open position O to the closed position.

If the sensors 8 detect any further object or person at the sliding door operator system 1 the control unit 7 will receive the information and regulate the drive unit 5 based on the input from the sensor 8.

The person skilled in the art realizes that the present invention by no means is limited to the preferred embodiments described above. On the contrary, many modifications and variations are possible within the scope of the appended claims.

The description of the aspects of the disclosure provided herein has been presented for purposes of illustration. The description is not intended to be exhaustive or to limit aspects of the disclosure to the precise form disclosed, and modifications and variations are possible in light of the above teachings or may be acquired from practice of various alternatives to the provided aspects of the disclosure. The examples discussed herein were chosen and described in order to explain the principles and the nature of various aspects of the disclosure and its practical application to enable one skilled in the art to utilize the aspects of the disclosure in various manners and with various modifications as are suited to the particular use contemplated. The features of the aspects of the disclosure described herein may be combined in all possible combinations of methods, apparatus, modules, systems, and computer program products. It should be appreciated that the aspects of the disclosure presented herein may be practiced in any combination with each other.

It should be noted that the word “comprising” does not necessarily exclude the presence of other elements or steps than those listed. It should further be noted that any reference signs do not limit the scope of the claims.

1. A sliding door operator system (1) for opening and closing an opening (2), comprising:
a track (3) configured to be mounted at an upper part (21) of the opening (2),
one or more sliding door(s) 10 slidably connected to the track (3) and comprising
a door leaf (4) configured to be moved along the track (3) between an open (0) and closed (C) position, and
a drive unit (5) mounted on the door leaf (4), moveably connected to the track (3) and arranged to move the door leaf (4) between the closed position (C) and the open position (0).

2. The sliding door operator system (1) according to claim 1, wherein the drive unit (5) comprises at least one wheel (51) arranged in the track (3) and at least one motor (52) connected to the wheel (51) and configured to rotate the wheel (51) to slidably move the door leaf (4) along the track (3).

3. The sliding door operator system (1) according to claim 2, wherein the drive unit (5) comprises a battery (53) connected to the motor (52) and configured to power the motor (52).

4. The sliding door operator system (1) according to claim 3, wherein the drive unit (5) comprises a capacitor (54) connected to the motor (52) and configured to power the motor (52).

5. The sliding door operator system (1) according to claim 4, comprising a charger station (6), wherein the battery (53) and/or capacitor (54) is configured to be connected to the charger station (6) and to be charged by the charger station (6).

6. The sliding door operator system (1) according to claim 5, wherein the battery (53) and/or the capacitor (54) is configured to be connected to the charging station (6) when the door leaf (4) is positioned in the open position (O) and/or the closed position (C).

7. The sliding door operator system (1) according to claim 5, wherein the charger station (6) comprises at least a first charging unit (61), arranged to be connected to and to charge the battery (53) and or capacitor (54) when the door leaf (4) is in the open position (0).

8. The sliding door operator system (1) according to claim 5, wherein the charger station (6) comprises at least a second charging unit (62), arranged to be connected to and to charge the battery (53) and/or the capacitor (54) when the door leaf (4) is in the closed position (C).

9. The sliding door operator system (1) according to claim 4, wherein the drive unit (5) comprises a bogie (55) and wherein the wheel (51) is suspended in a wheel suspension (56) of the bogie (55).

10. The sliding door operator system (1) according to claim 9, wherein the bogie (55) is connected to the door leaf (4).

11. The sliding door operator system (1) according to claim 9, wherein the battery (53) is mounted on the bogie (55).

12. The sliding door operator system (1) according to claim 9, wherein the capacitor (54) is mounted on the bogie (55).

13. The sliding door operator system (1) according to claim 2, wherein the motor (52) is arranged in the wheel (51).

14. The sliding door operator system (1) according to claim 2, wherein the motor (52) constitutes a centre shaft of the wheel (51).

15. The sliding door operator system (1) according to claim 2, wherein the wheel (51) is configured to rotate around at least parts of the motor (52)

16. The sliding door operator system (1) according to claim 9, wherein the motor (51) is mounted on the bogie (55).

17. The sliding door operator system (1) according to claim 1, wherein the one or more sliding door(s) (10) comprises a control unit (7) configured to regulate the drive unit (5) to move the door leaf (4) between the closed position (C) and the open position (0).

18. The sliding door operator system (1) according to claim 1, comprising one or more sensors (8) configured to detect objects at the sliding door operator system (1).

19. The sliding door operator system (1) according to claim 18, wherein at least one of the sensors (8) is mounted on at least one of the sliding door (10).

20. The sliding door operator system (1) according to claim 1, wherein the sliding door (10) comprises at least two drive units (5).

21. The sliding door operator system (1) according to claim 1, comprising a first and a second sliding doors (10, 10a, 10b) and a control system (11), wherein the control system (11) is configured to regulate the first sliding door (10a) to move between the open and closed position (O, C) of the first sliding door (10a) and to regulate the second sliding door (10b) to move between its open and closed position (O, C) of the second sliding door (10b).

22. The sliding door operator system (1) according to claim 21, wherein the control system (11) is configured to regulate the movement of the first sliding door (10a) independently of the movement or position of the second sliding door (10b).

23. The sliding door operator system (1) according to claim 21, wherein the control system (11) is configured to regulate the movement of the first and second sliding doors (10a, 10b) at least based on input from one or more sensors (8).

24. The sliding door operator system (1) according to claim 21, wherein the control system (11) is connected to a control unit (7) of each sliding door (10) and configured to regulate the control unit (7) to regulate the drive unit (5) to move the door leaf (4).

25. The sliding door operator system (1) according to claim 2, wherein the drive unit (5) comprises at least one a spline joint (58) connected between the wheel (51) and the motor (52) and arranged to compensate for movements in an axial direction of the wheel (51) in relation to the motor (52).

26. The sliding door operator system (1) according to claim 2, wherein the track (3) is configured to restrict movement of the wheel (51) in an axial direction of the wheel (51).

27. The sliding door operator system (1) according to claim 2, wherein a rolling surface (59) of the wheel (51) and a rolling surface (31) of the track (3) have a corresponding shape.

28. The sliding door operator system (1) according to claim 27, wherein the rolling surface of the wheel (51) and the rolling surface of the track (3) is made of a material with a higher friction than other surfaces of the track (3) and the wheel (51) to restrict the wheel (51) from spinning or sliding in the track (3).

29. The sliding door operator system (1) according to claim 1, wherein a cross sectional shape of the track (3) has a C-shape or a U-shape.

30. The sliding door operator system (1) according to claim 2, wherein the track (3) comprises restriction parts (32) configured to restrict movements of the wheel (51) in an axial direction of the wheel (51).

31. The sliding door operator system (1) according to claim 30, wherein a side surface (71) of the wheel (51) is made of a material with a lower friction than other surfaces of the wheel (51) to reduce the friction between the side surface (71) and the restriction parts (32).

32. The sliding door operator system (1) according to claim 2, wherein the drive unit (5) comprises a gear box (60) connected to the wheel (51) and the motor (52) and configured to transfer movements from the motor (52) to the wheel (51).

33. A sliding drive unit (5) for moving a sliding door leaf (4) between an open and a closed position (0, C), wherein
the drive unit (5) is configured to be mounted on the sliding door leaf (4) and to interact with a track (3) at an upper part (21) of an opening (2) to move the sliding door leaf (4) and the drive unit (5) in relation to the track (3).

34. The drive unit (5) according to claim 33, comprising at least a wheel (51) and a motor (52), wherein the motor (52) is connected to the wheel (51) and configured to rotate the wheel (51), and the wheel (51) is configured to be arranged in the track (3).

35. The drive unit (5) according to claim 34, comprising a battery (53) connected to the motor (51) and configured to power the motor (51).

36. The drive unit (5) according to claim 35, comprising a capacitor (54) connected to the motor (52) and configured to power the motor (52).

37. The drive unit (5) according to claim 36, wherein the battery (53) and or capacitor (54) is configured to be connected to a charger station (6) and to be charged by the charger station (6).

38. The drive unit (5) according to claim 37, wherein the battery (53) and/or the capacitor (54) is configured to be connected to the charging station (6) when the door leaf (4) is positioned in the open position (0) and/or the closed position (C).

39. The drive unit (5) according to claim 36, comprising a bogie (55) and wherein the wheel (51) is suspended in a wheel suspension (56) of the bogie (55).

40. The drive unit (5) according to claim 39, wherein the bogie (55) is configured to be connected to the door leaf (4).

41. The drive unit (5) according to claim 39, wherein the battery (53) is mounted on the bogie (55).

42. The drive unit (5) according to claim 39, wherein the capacitor (54) is mounted on the bogie (55).

43. The drive unit (5) according to claim 34, wherein the motor (52) is arranged in the wheel (51).

44. The drive unit (5) according to claim 34, wherein the motor (52) constitutes a centre shaft (57) of the wheel (51).

45. The drive unit (5) according to claim 34, wherein the wheel (51) is configured to rotate around at least parts of the motor (52).

46. The drive unit (5) according to claim 39, wherein the motor (52) is mounted on the bogie (55).

47. The drive unit (5) according to claim 34, wherein the drive unit (5) comprises at least one a spline joint (58) connected between the wheel (51) and the motor (52) and arranged to compensate for movements in an axial direction of the wheel (51) in relation to the motor (52).

48. The drive unit (5) according to claim 34, wherein a rolling surface (59) of the wheel (51) has a corresponding shape as a rolling surface (31) of the track (3).

49. The drive unit (5) according to claim 34, wherein a rolling surface (59) of the wheel (51) is made of a material with a higher friction than other surfaces of the wheel (51) to restrict the wheel (51) from spinning or sliding in the track (3).

50. The drive unit (5) according to claim 34, wherein a side surface (71) of the wheel (51) is made of a material with a lower friction than other surfaces of the wheel (51).

51. The drive unit (5) according to claim 34, comprising a gear box (60) connected to the wheel (51) and the motor (52) and configured to transfer movements from the motor (52) to the wheel (51).

52. A control system (11) for regulating one or more sliding door(s) (10) according to the sliding door operator system of claim 1, comprising a central control unit (74) configured to be connected to a control unit (7) of the one or more sliding doors (10) and to regulate the control unit (7) to move the door leaf (4) of the one or more sliding doors (10) between the open and the closed position (O, C).

53. The control system (11) according to claim 52, wherein the central control unit (74) is configured to regulate each control unit (7) individually and independently of other sliding doors of the one or more sliding doors (10).
